(19) United States
(12) Patent Application Publication
(10) Pub. No.: US 2025/0377161 A1
(43) Pub. Date: Dec. 11, 2025

(54) DEVICE AND METHOD FOR DRYING SPORTING EQUIPMENT SUCH AS FOOTBALLS

(71) Applicant: Benjamin E. Fossey, Minnetonka, MN (US)

(72) Inventor: Benjamin E. Fossey, Minnetonka, MN (US)

(21) Appl. No.: 18/734,141

(22) Filed: Jun. 5, 2024

(51) Int. Cl. F26B 25/16; A63B 47/00; F26B 3/04; F26B 21/00; F26B 23/00

(52) U.S. Cl. CPC F26B 25/16; A63B 47/00; F26B 3/04; F26B 21/004; F26B 23/00

(57) ABSTRACT

A dryer and method for drying a ball may include a housing defining an enclosure and including a plurality of walls and a door. A dryer and method and method may include at least one ball support. A dryer and method may include a blower mechanism including: an air inlet that draws air from outside the enclosure, a fan, a motor operably connected to the fan, a power source for the motor, a heating element downstream of the fan, an exhaust port directing an airstream generated by the fan toward the ball support inside the enclosure. A dryer and method may include exit holes defined by the housing that allow water and moist air to escape the enclosure.

### BACKGROUND OF THE INVENTION

Most forms of sporting equipment become more difficult to use when wet. Footballs are particularly problematic when wet given the manner in which they are thrown, caught, held while being tackled, kicked, etc. Footballs get wet due to rain, moisture from the playing field, and sweat from the players handling the balls.

The rules of football vary slightly based on the level being played, but generally, footballs must be made of pebble-grained leather which is a natural tan color. Additionally, the condition ball may not be altered using a chemical ball-drying or ball-warming substance. Leather naturally absorbs water and becomes slippery.

The hosting team is required to provide three legal balls to the game officials for measurement and inspection 60 minutes prior to the start of the game. At some levels, the balls are to remain under the supervision of the officials throughout the game. During rainy weather, efforts are made to dry the footballs with towels and the footballs are swapped numerous times during each drive. The drying efforts are often ineffective as the towels become wet and the football leather gets soaked.

Tom Brady of the New England Patriots and the Tampa Bay Buccaneers would famously shove towels down the back of center's pants in order to keep the football free of bodily sweat from the center while hiking the ball. It is thus evident that there is a need for a more efficient way of keeping footballs dry during a game.

### OBJECTS AND SUMMARY OF THE INVENTION

The present invention addresses the aforementioned need by providing a portable, electro-mechanical device for drying sporting equipment, especially balls such as footballs and soccer balls. The device may use a variety of combinations of heat, air, and centrifugal force.

In some embodiments, an enclosure is provided containing a blower mechanism and room for the ball.

The mechanism may take the form of a heated, forced-air blower that directs a stream of hot air onto the ball.

In other embodiments, the ball is able to spin, either passively as a result of the airflow, or actively driven by a spinning mechanism, such that excess water is flung from the ball during the drying process.

In some embodiments, the enclosure is sized to contain the drying mechanism and a single ball.

In other embodiments, the enclosure is sized to contain the drying mechanism and two or more balls.

In some embodiments, the ball drying mechanism includes more than one dryer.

In some aspects, the techniques described herein relate to a device for drying sporting equipment such as a ball including: a housing defining an enclosure and including a plurality of walls and a door; at least one ball support; a blower mechanism including: an air inlet that draws air from outside the enclosure; a fan; a motor operably connected to the fan; a power source for the motor; a heating element downstream of the fan; an exhaust port directing an airstream generated by the fan toward the ball support inside the enclosure; exit holes defined by the housing that allow water and moist air to escape the enclosure.

In some aspects, the techniques described herein relate to a device wherein the blower mechanism is mounted to an inside surface of the enclosure.

In some aspects, the techniques described herein relate to a device wherein the plurality of walls includes a rear wall, a top wall, a bottom wall, and two side walls.

In some aspects, the techniques described herein relate to a device wherein the blower mechanism is mounted to a rear wall of the enclosure.

In some aspects, the techniques described herein relate to a device wherein the fan includes a squirrel cage fan.

In some aspects, the techniques described herein relate to a device wherein the at least one ball support includes one ball support.

In some aspects, the techniques described herein relate to a ball drying device including: a housing defining an enclosure with a door, a top wall, opposing side walls, a back wall and a bottom wall; a rotatable ball support; a blower mechanism that creates first and second heated airstreams directed at the rotatable ball support; exit holes defined by the housing that allow water and moist air to escape the enclosure; wherein, during operation, a ball placed on the rotatable ball support spins about an axis of symmetry causing centrifugal force acting on the ball to aid in drying the ball.

In some aspects, the techniques described herein relate to a device wherein the first and second heated airstreams are directed at the rotatable ball support offset from an axis of rotation such that the first and second airstreams cause the ball placed on the rotatable ball support to spin.

In some aspects, the techniques described herein relate to a device wherein the blower mechanism includes first and second blowers.

In some aspects, the techniques described herein relate to a device wherein each of the first and second blowers include: a fan; a motor powering the fan; and, a heating element disposed in an exhaust of the fan.

In some aspects, the techniques described herein relate to a device wherein the first and second blowers are mounted within the enclosure.

In some aspects, the techniques described herein relate to a device wherein the fans of the first and second blowers are squirrel cage fans.

In some aspects, the techniques described herein relate to a device wherein the rotatable ball support is rotated by a motor.

In some aspects, the techniques described herein relate to a device wherein the exit holes defined by the housing are located in the bottom wall.

In some aspects, the techniques described herein relate to a device wherein the first and second blowers are mounted on the opposing side walls.

In some aspects, the techniques described herein relate to a method for drying a ball including: placing the ball in an enclosure; supporting the ball on a support within the enclosure; directing at least one stream of heated air at the ball; allowing moisture to escape the enclosure.

In some aspects, the techniques described herein relate to a method further including: spinning the ball around an axis of symmetry.

In some aspects, the techniques described herein relate to a method wherein: supporting the ball on the support within the enclosure includes supporting the ball on a spinnable support; directing the at least one stream of heated air at the ball such that the stream impinges the ball offset from the axis of symmetry.

In some aspects, the techniques described herein relate to a method wherein directing the at least one stream of heated air at the ball includes directing two streams of air at the ball such that each stream impinges the ball offset from the axis of symmetry.

In some aspects, the techniques described herein relate to a method wherein: supporting the ball on the support within the enclosure includes supporting the ball on a spinnable support; spinning the spinnable support.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a front elevation of an embodiment of a dryer according to the invention;

FIG. 2 is a front elevation of an embodiment of a dryer according to the invention with a front door opened to show inside detail;

FIG. 3 is a front elevation of an embodiment of a dryer according to the invention;

FIG. 4 is a front elevation of an embodiment of a dryer according to the invention with a front door opened to show inside detail.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

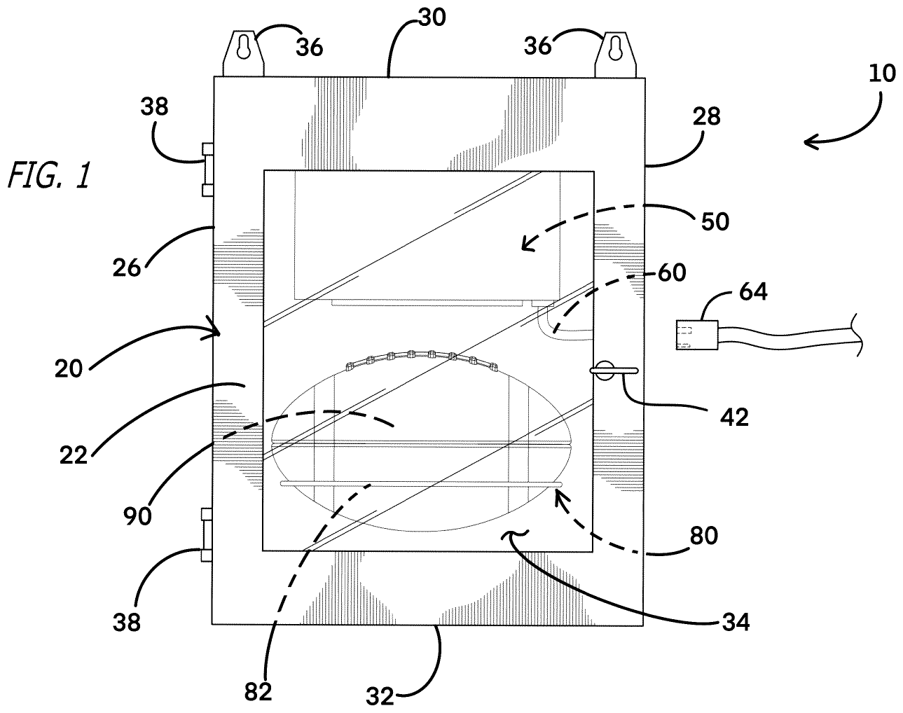

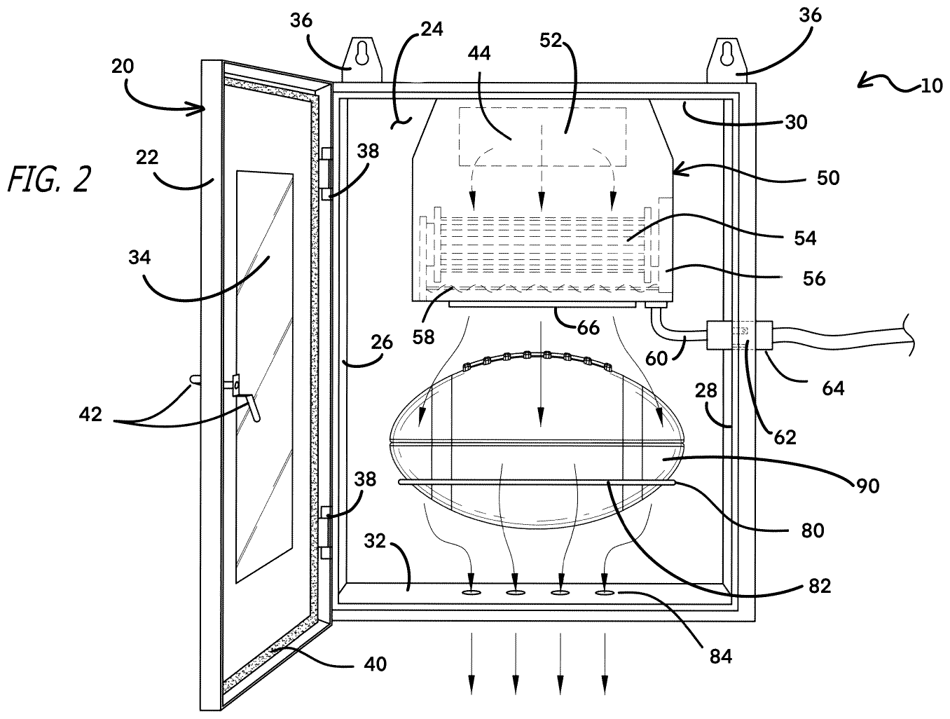

Turning now to the figures, FIGS. 1 and 2 show an embodiment of a dryer 10 according to the invention. The dryer 10 generally includes a housing 20 that includes a door 22, a rear wall 24, side walls 26 and 28, a top wall 30 and a bottom wall 32. The door 22 is shown as optionally including a window 34.

Attached to external surfaces of the housing 20, are optional mounting brackets 36 and hinges 38 that allow the door 22 to swing open and closed. In at least one embodiment, the door 22 includes a gasket 40, such as a dust seal, an IP67 rated dust seal, a waterproof gasket like those found on waterproof cases, or even a magnetic sealing strip like those commonly used on refrigerators, freezers, and the like. The door 22 is also shown as including a latch 42.

As best seen in FIG. 2, the inside of the dryer 10 generally includes a blower mechanism 50 and a ball support 80. The blower mechanism 50 may be mounted to an interior surface of the housing 20, such as the rear wall 24 as shown, and includes an air inlet 52 aligned with a corresponding inlet opening 44 through the interior surface to which the blower mechanism 50 is mounted, such as the rear wall 24. Air entering the inlet 52 is drawn into the blower mechanism 50 by a fan 54, shown as a squirrel cage fan, powered by a motor 56. Downstream of the fan 54 is a heating element 58 that heats and dries the airstream.

The motor 56 receives electricity via a power cord 60. The power cord 60 may pass through one of the walls and have a length sufficient to reach an outlet. In the embodiment shown in FIG. 2, the power cord 60 terminates at a male outlet 62 with prongs 64 extending through the side wall 28, allowing an extension cord 64 of a desired length be selected to provide power from a source outlet to the dryer 10.

Below the heating element 58 is a blower exhaust 66 from which the heated airstream flows. The blower exhaust 66 is directed at the ball support 80, which in operation, supports a ball 90. The ball support 80 may be a wire 82 sized and shaped to support a ball 90 for which the dryer 10 is designed. The ball support 80 may be connected to one or more of the interior walls. The wire or similar material from which the ball support 80 is constructed is selected to sturdily support the ball while under the pressure of the airstream, without covering a significant portion of the ball 90 such that the surface of the ball 90 being dried is maximized.

In order to promote airflow, and to provide an exit for moisture, air/water exit holes 84 are provided through the bottom wall 32 through which water from the ball 90 may drain as well as moist air that has already flowed over the surface of the ball 90.

One skilled in the art will understand that the housing 20 could be sized and configured to accommodate more than one ball support 80 such that multiple balls could be dried at once, without departing from the spirit of the invention.

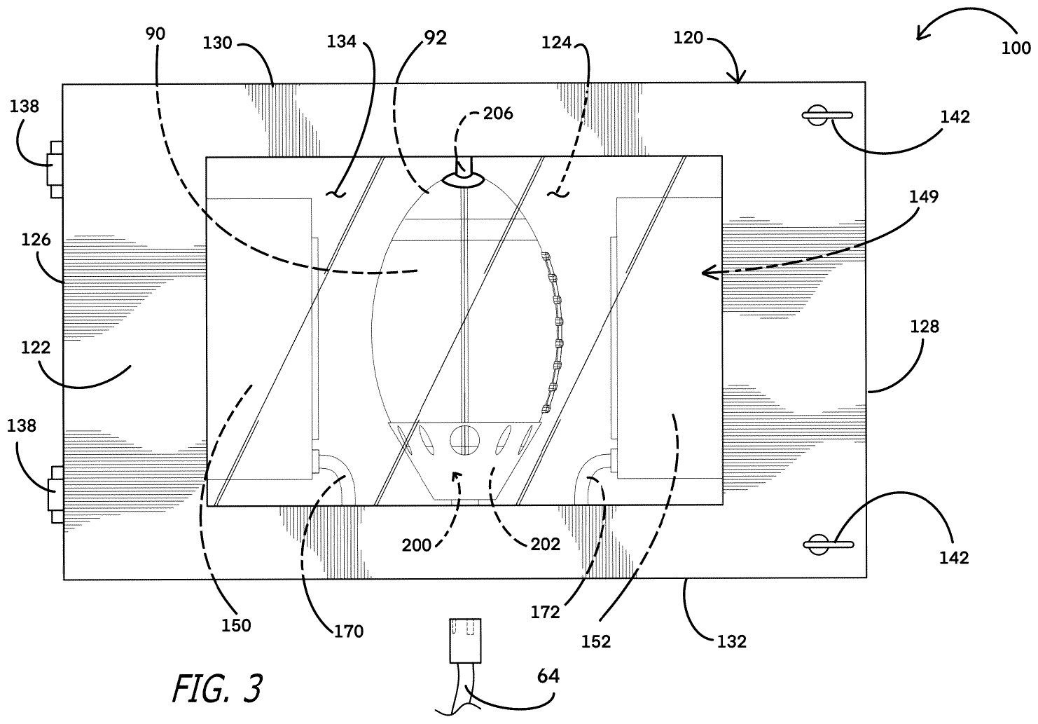

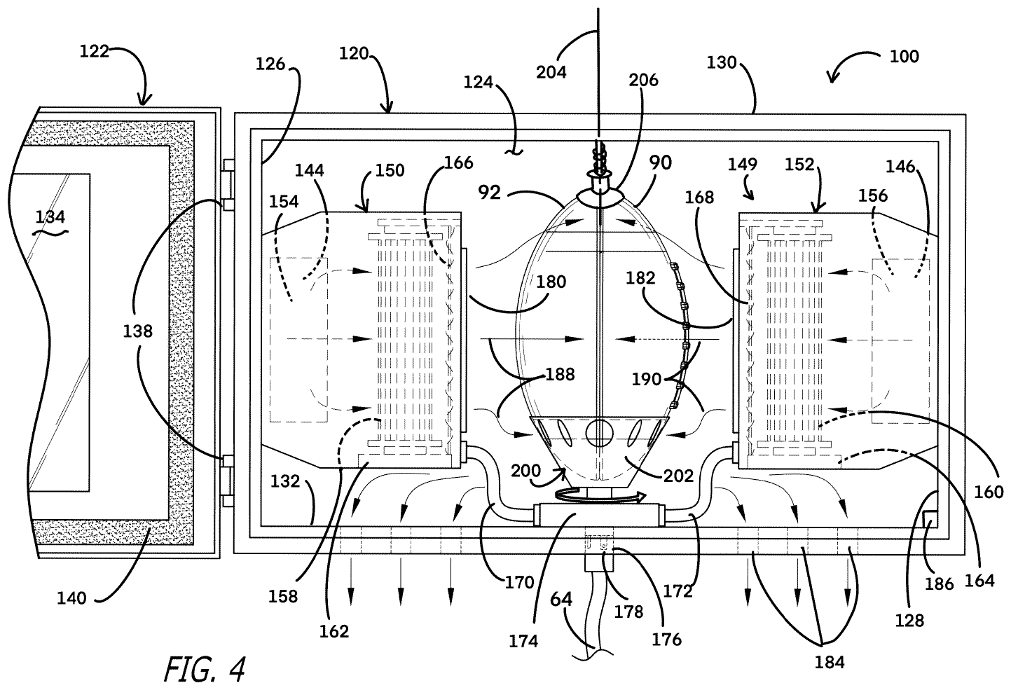

Referring now to FIGS. 3 and 4, another embodiment of a dryer 100 is shown. The dryer 100 generally includes a housing 120 that includes a door 122, a rear wall 124, side walls 126 and 128, a top wall 130 and a bottom wall 132. The door 122 is shown as optionally including a window 134 and may include latches 142.

Attached to external surfaces of the housing 120, are hinges 138 that allow the door 122 to swing open and closed. In at least one embodiment, the door 122 includes a gasket 140, which may be similar to gasket 40.

As best seen in FIG. 3, the inside of the dryer 100 generally includes blower mechanism 149 that includes a first blower 150, a second blower 152 and a ball support mechanism 200. The first and second blowers 150 and 152 may be mounted to an interior surface of the housing 120, such as the rear wall 124 as shown, and each includes a respective air inlet 154, 156 aligned with a corresponding inlet opening 144, 146 through the interior surface(s) to which the first and second blowers 150, 152 are mounted, which may be a common surface such as the rear wall 124 as shown, or different surfaces such as side walls 124, 126, or any combination of any of the interior wall surfaces.

Air entering the inlets 154, 156 is drawn into the first and second blowers 150, 152 by respective fans 158, 160, shown as a squirrel cage fans, powered by motors 162, 164. Downstream of the fans 162, 164 are heating elements 166, 168 that heat and dry respective airstreams 188 and 190.

The motors 162, 164 receive electricity via power cords 170, 172. The power cords 170, 172 may pass through one of the walls and have a length sufficient to reach an outlet. In the embodiment shown in FIG. 4, the power cords 170, 172 terminate at a junction box 174 that includes a male outlet 176 with prongs 178 extending through the bottom wall 128, allowing an extension cord 64 of a desired length be selected to provide power from a source outlet to the dryer 100. A safety switch 186 may be provided on one or both embodiments of dryer 10 and dryer 100, that cuts power to the devices when the doors are open to prevent potential injury.

Adjacent the heating elements 166, 168 are blower exhausts 180, 182 from which the heated airstreams 188, 190 flow. The blower exhausts 180, 182 are arranged to direct the airstreams 188, 190 at the ball support 200, which in operation, supports a ball 90. The ball support 200 may be in the form of a rotating cup 202 that is sized and shaped to support a ball 90 for which the dryer 100 is designed. The ball support 200 may be connected to one or more of the interior walls.

As seen in FIG. 4, the ball support 200 is mounted atop the junction box 174, which is mounted to the bottom wall 132. The ball support 200 rotates around a vertical axis 204 and is constructed to support the football vertically such that a longitudinal axis of symmetry of the football 90 is aligned with the vertical axis 204 of the football 90. This allows the upper end 92 of the football 90 to be contained by a light, rotatable support 206. The support 206 is shown as a spring-loaded support that allows easy insertion and removal of the football.

In order to promote airflow, and to provide an exit for moisture, air/water exit holes 184 are provided through the bottom wall 132 through which water from the ball 90 may drain as well as moist air that has already flowed over the surface of the ball 90.

One skilled in the art will realize that an embodiment may be provided whereby the football is mounted horizontally between upper and lower blower fans. This configuration, however, may require more robust supports to hold the pointed ends of the football. This may also result in an enclosure that is taller than it is wide and may not be as sturdy as the configuration shown.

In at least one embodiment, the ball support 200 of FIG. 4 spins passively with the spinning energy imparted on the ball 90 coming from airstreams 188, 190 being slightly offset from the vertical axis 204 in opposite directions. Thus, each heated airstream 188, 190 strikes a side of the ball 90 that rotates the ball in a complimentary direction, either clockwise or counterclockwise. The spinning motion aids in the speedy drying process as some of the water on the ball 90 is ejected from the ball's surface due to centrifugal force. Additionally, the entire surface of the ball dries evenly without human interaction.

Alternatively, the ball support 200 may be powered by a motor (not shown) contained within the junction box 174, or elsewhere, that is operably connected to the spinning support 200 such that the motor actively powers the rotation of the ball support 200. In this embodiment, offsetting the blower exhausts 180 and 182 from the vertical axis 204 is not necessary. The ball support 200 could alternatively be driven by a turbofan placed in one or more of the exhaust streams of the blower(s).

One skilled in the art will understand that the housing 120 could be sized and configured to accommodate more than one ball support 200 such that multiple balls could be dried at once, without departing from the spirit of the invention.

One skilled in the art will further understand that the blower mechanism 50 of the dryer 10, and/or blower mechanism 149 of the dryer 100, may be mounted on external surfaces of the housing 20 or housing 120, respectively, with the blower exhaust 66 and/or blower exhausts 180, 182 exhausting heated airstreams into the enclosure and impinging on the ball 90 contained therein accordingly. Alternatively, the blower mechanism 10, 149 may be separate from the housing 20, 120 and utilize one or more exhaust hoses that connect to the housing 20, 120 to direct hot airstreams onto the ball being dried. This embodiment may allow the housing to be connected to hand dryers, such as found in a locker room, to provide a much less expensive option to a purchaser.

Alternatively, in the spirit of the passive spinning embodiment of ball support 200, one or more blower mechanisms, preferably but optionally heated, could have exhausts connected to hose(s) that are routed through one or more walls of the enclosures and onto the ball 90 contained therein. This embodiment may be advantages in that the enclosure volume may be significantly reduced, potentially reducing the time and/or energy needed to create a dry environment for drying the ball 90.

One embodiment of the invention is thus a method of drying a ball, such as a football or rugby ball or any other ball used in sports, that includes the steps of providing a housing having an enclosure containing a ball support and a supply of heated air that flows through the enclosure; placing a ball to be dried into the enclosure, which may involve placing the ball on a ball support within the enclosure; closing a door of the enclosure; and causing heated air to flow over the ball until the ball has reached a desired level of dryness. The method may further include cutting power to the device in the event the door is of the enclosure is opened. The method may also include allowing the ball to spin as a result of the heated air impinging on the ball. The method may also or alternatively include spinning the ball using a motorized drive.

It is also contemplated, and considered within the scope of the invention, to include added safety features. For example, the drying mechanisms should be connected to a timing device that shuts off automatically once a predetermined period of time has elapsed or a threshold temperature inside the enclosure is reached. As another example, preventative measures may be used to prevent contamination of the ball or the inside of the enclosure. Various types of filters, antibacterial, HEPA, etc., may be used to filter the air entering the enclosure. Ultraviolet radiation (e.g. UVC) may be used to disinfect the inside of the enclosure.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A device for drying sporting equipment such as a ball comprising:
a housing defining an enclosure and including a plurality of walls and a door;
at least one ball support;
a blower mechanism including:
an air inlet that draws air from outside the enclosure;
a fan;
a motor operably connected to the fan;
a power source for the motor;
a heating element downstream of the fan;
an exhaust port directing an airstream generated by the fan toward the ball support inside the enclosure;
exit holes defined by the housing that allow water and moist air to escape the enclosure.

2. The device of claim 1 wherein the blower mechanism is mounted to an inside surface of the enclosure.

3. The device of claim 1 wherein the plurality of walls includes a rear wall, a top wall, a bottom wall, and two side walls.

4. The device of claim 2 wherein the blower mechanism is mounted to a rear wall of the enclosure.

5. The device of claim 1 wherein the fan comprises a squirrel cage fan.

6. The device of claim 1 wherein the at least one ball support comprises one ball support.

7. A ball drying device comprising:
a housing defining an enclosure with a door, a top wall, opposing side walls, a back wall and a bottom wall;
a rotatable ball support;
a blower mechanism that creates first and second heated airstreams directed at the rotatable ball support;
exit holes defined by the housing that allow water and moist air to escape the enclosure;
wherein, during operation, a ball placed on the rotatable ball support spins about an axis of symmetry causing centrifugal force acting on the ball to aid in drying the ball.

8. The device of claim 7 wherein the first and second heated airstreams are directed at the rotatable ball support offset from an axis of rotation such that the first and second airstreams cause the ball placed on the rotatable ball support to spin.

9. The device of claim 7 wherein the blower mechanism comprises first and second blowers.

10. The device of claim 9 wherein each of the first and second blowers comprise:
a fan;
a motor powering the fan; and,
a heating element disposed in an exhaust of the fan.

11. The device of claim 9 wherein the first and second blowers are mounted within the enclosure.

12. The device of claim 10 wherein the fans of the first and second blowers are squirrel cage fans.

13. The device of claim 7 wherein the rotatable ball support is rotated by a motor.

14. The device of claim 7 wherein the exit holes defined by the housing are located in the bottom wall.

15. The device of claim 11 wherein the first and second blowers are mounted on the opposing side walls.

16. A method for drying a ball comprising:
placing the ball in an enclosure;
supporting the ball on a support within the enclosure;
directing at least one stream of heated air at the ball;
allowing moisture to escape the enclosure.

17. The method of claim 16 further comprising:
spinning the ball around an axis of symmetry.

18. The method of claim 17 wherein:
supporting the ball on the support within the enclosure comprises supporting the ball on a spinnable support;
directing the at least one stream of heated air at the ball such that the stream impinges the ball offset from the axis of symmetry.

19. The method of claim 18 wherein directing the at least one stream of heated air at the ball comprises directing two streams of air at the ball such that each stream impinges the ball offset from the axis of symmetry.

20. The method of claim 17 wherein:
supporting the ball on the support within the enclosure comprises supporting the ball on a spinnable support;
spinning the spinnable support.
